(19) United States
(12) Patent Application Publication
(10) Pub. No.: US 2012/0085794 A1
(43) Pub. Date: Apr. 12, 2012

(54) COLLAPSIBLE SPOUT FOR A CONTAINER AND METHOD OF MANUFACTURE THEREOF

(75) Inventors: John R. SELINA, Brighton, MI (US); Randall J. CORBETT, Macomb, MI (US)

(73) Assignee: LETICA CORPORATION, Rochester, MI (US)

(21) Appl. No.: 12/898,768

(22) Filed: Oct. 6, 2010

(51) Int. Cl. B67D 3/00

(52) U.S. Cl. 222/530; 222/529

(57) ABSTRACT

A manually extendible plastic spout for use in combination with the closure for an industrial container. The spout has a peripheral flange with a U-shaped channel which receives a downwardly extending flange on the closure so that the spout is installed from the bottom side of the closure rather than according to the more customary top-mounted procedure. The body of the spout is pleated and has an outlet collar which is threaded to receive a cap having a pull-ring, an integral internal seal is also provided. The spout can be extended to any of several stable positions or conditions.

### FIELD OF THE INVENTION

This invention relates to collapsible spouts for installation in closures for open top containers and more particularly to a spout having a pleated body which is manually extendible from a collapsed condition within an opening in the closure to a stable, extended condition in which pouring from the container is facilitated.

### BACKGROUND OF THE INVENTION

It is known to install collapsible, but manually extendible, spouts in the closure decks of industrial containers for the purpose of facilitating the act of pouring out the contents of the container. One common spout uses a “roll sock” configuration wherein the soft plastic body of the spout is gradually turned inside out as the spout is extended. Roll sock spouts typically have three pieces and are of limited height.

### SUMMARY OF THE INVENTION

The present invention provides an improved collapsible, manually extendible spout which is characterized by fewer parts and greater height potential. In general, the spout of the present invention comprises a molded plastic body comprising a plurality of concentric pleats. At the larger diameter inlet end of the body, a peripheral U-shaped channel is formed which receives a downwardly extending peripheral flange on the underside of the closure deck such that the spout is installed from and attached to the underside or interior side of the closure rather than the top or exterior side. At the other end of the pleated body, there is formed an integral and externally threaded collar which receives an internally threaded cap. This cap is normally flush with the top of the container deck when the spout is in the collapsed condition and includes a pull-ring to assist the user in extending the spout.

In the preferred embodiment described herein, the pull-ring is formed integrally with the cap and around the periphery thereof so that a person may grasp the pull-ring with two or more fingers, lift it up and away from its resting plane and exert an upward pressure on the spout through the cap so as to extend the spout into a stable partially or fully extended condition.

Also in the preferred embodiment hereinafter described in detail, a seal with a pull-ring is formed integrally inside of the spout collar so as to protect the contents of the container until such time as one desires to deploy the spout and gain access to such contents.

According to a second aspect of the invention, the pleated body of the spout is molded in the collapsed condition with all of the pleats of the body as well as the outlet collar concentrically within one another in essentially the same plane.

### BRIEF SUMMARY OF THE DRAWINGS

The description herein makes reference to the accompanying drawings wherein like reference numerals refer to like parts throughout the several views and wherein:

FIG. 1 is a perspective view of a container comprising a lock-on closure equipped with a collapsible spout in accordance with the invention;

FIG. 2 is a perspective view partly in section showing the construction of the spout and the closure deck in which the spout is mounted;

FIG. 3 shows the spout of FIG. 1. 2 in an extended condition;

FIG. 4 is a side view of the spout showing how it can be asymmetrically extended; and

FIG. 5 is another view showing an asymmetric extension of the spout.

### DETAILED DESCRIPTION OF THE ILLUSTRATIVE EMBODIMENT

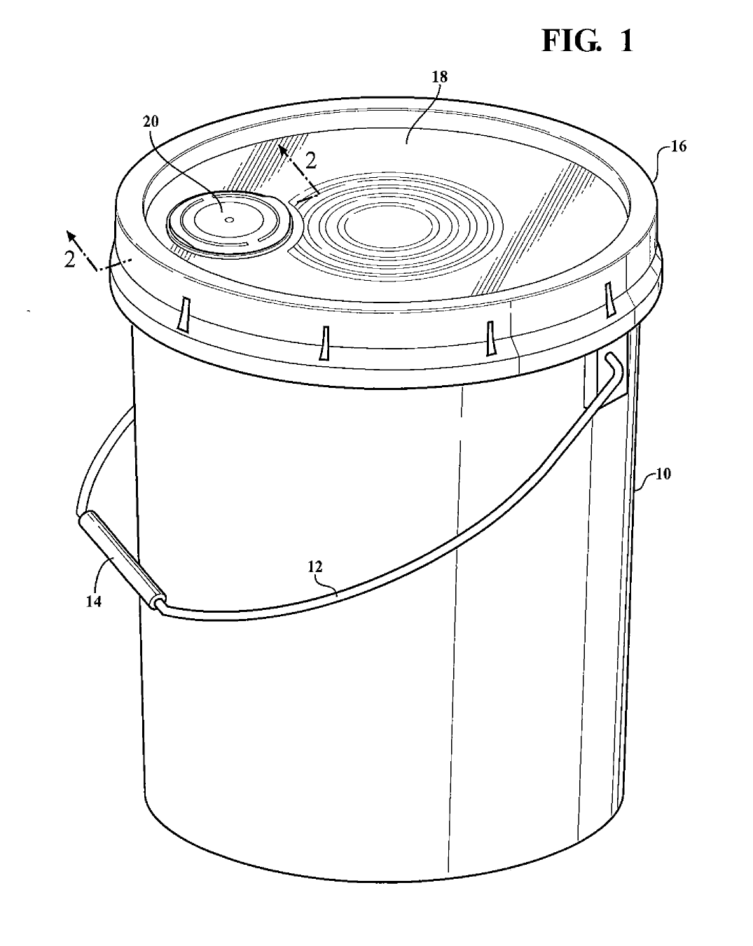

Referring to FIGS. 1 through 3, a five-gallon open-top molded container 10 is shown to be equipped with a bail 12 having a handle 14. The open top (not shown) of the container 10 is sealingly closed by a molded plastic closure 16 of well known design. Both the container 10 and the closure 16 are often and advantageously injection molded of high-density polyethylene; however, many other materials of construction may be used. The size of the container is given by way of example only.

The closure 16 is characterized by a generally flat central deck 18 having formed therein a circular opening which receives therein a two-piece spout assembly 20. The opening in the deck has a downwardly (or inwardly, relative to the interior of the container 10) extending flange 22 with an annular detent head for purposes to be described.

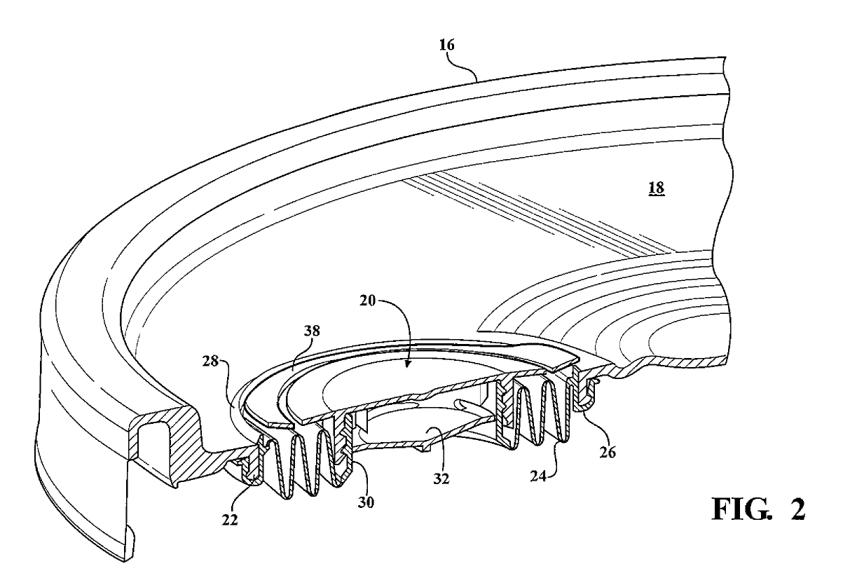

The spout assembly 20 comprises a molded plastic, concentrically-pleated spout body 24 which is molded with the pleated portions thereof concentric and in the collapsed condition shown in FIG. 2. The body of the spout has a large diameter inlet end 26 with a U-shaped peripheral channel adapted to lockingly receive the inwardly extending flange 22 of the closure deck 18 such that the spout is installed from the interior or underside of the closure deck; i.e., the spout 24 is inserted from the underside or bottom of the deck 18 and pushed upwardly into locking engagement with the flange 22. A peripheral flange 28 on the top of the U-shaped channel 26 seats against the top of the deck 18 just around the outside of the circular opening to provide a seal.

The smaller diameter or outlet end of the spout body is defined by a generally cylindrical collar 30 having external spiral threads formed thereon to receive a cap 36 which forms the second component of the spout assembly. The cap 36 comprises a cylindrical body portion 37 with internal threads to mate with the external threads of the collar 30. The cap 36 is equipped with an integral pull-ring 38 around the outer periphery thereof to exhibit the largest possible diameter. The pull-ring 38 is partially separated from the cap body by a circular gap or slot so that the pull-ring may be lifted and grasped in the hand when one wishes to extend the spout. In short, the spout is extended by grasping the pull-ring 38 with the cap 36 attached to the collar 30 and pulling upwardly until the pleats begin to unfold into any of various stable configurations.

A secondary seal 32 is formed integrally within the collar 30 and has its own pull-ring 34 in conventional fashion for selective removal when one wishes to deploy the spout and gain access to the contents of the container.

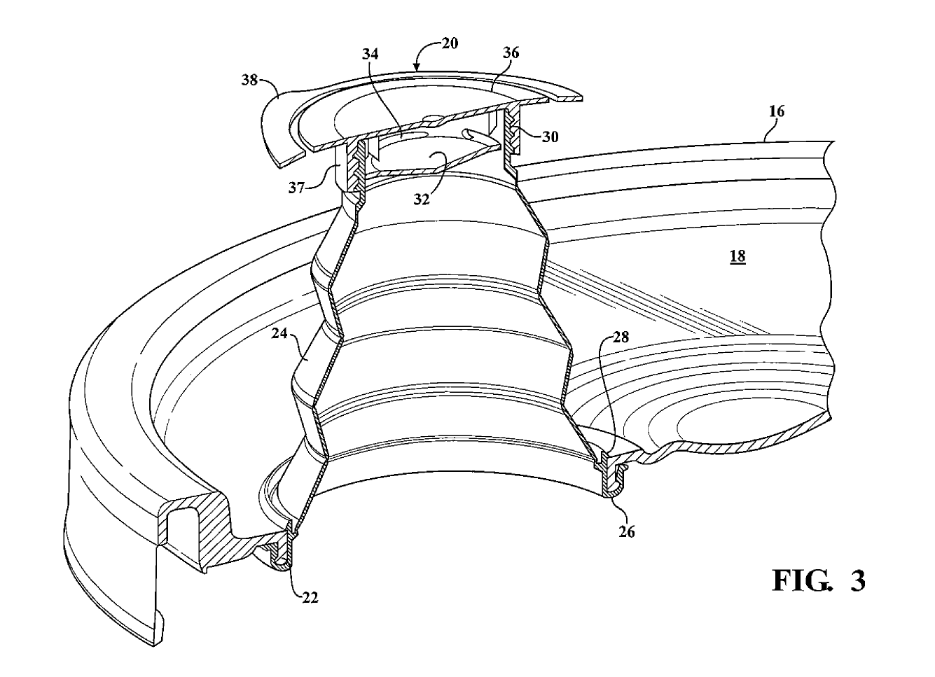

In a practical embodiment, the circular opening in the deck 18 is on the order of three inches in diameter and the remaining components of the assembly as shown in the Figures are scaled according to that dimension. It is apparent from FIGS. 2 and 3 that the pleated spout exhibits a large extension height thus making the act of pouring from the container 10 easier and less likely to produce spills.

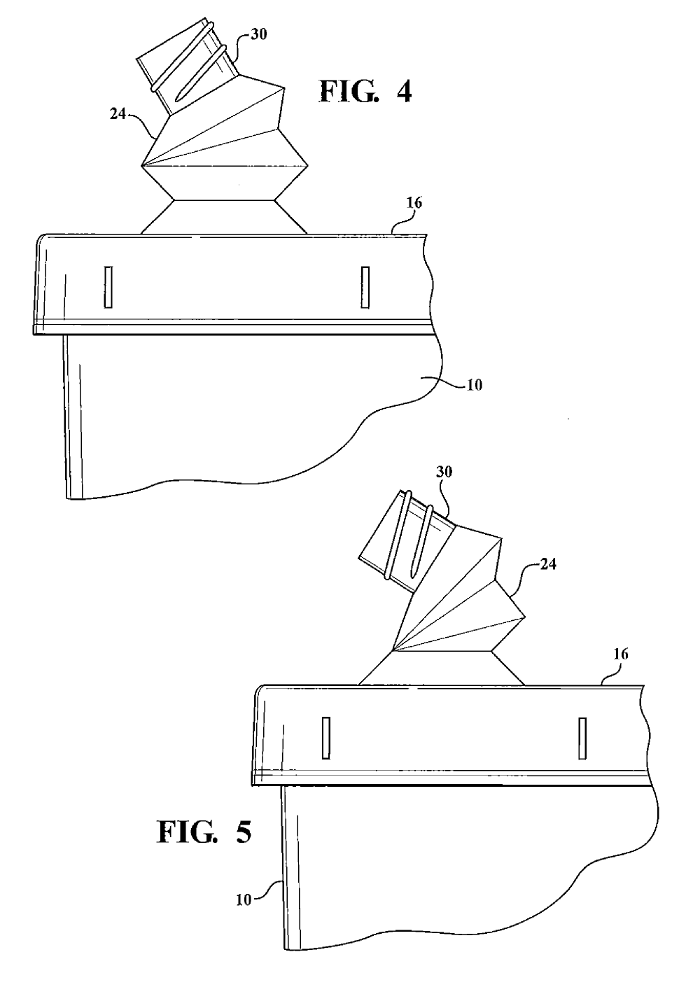

As shown in FIGS. 4 and 5, the spout 24 can be extended symmetrically and asymmetrically; i.e., the latter being characterized by a greater degree of pleat extension on one side of the spout than on the other thus to place the spout 24 in a “cocked” condition. The material of the body 24 tends to be thinner at the pleats and one will note an “over-center” release as each pleat is unfolded.

The method of the present invention comprises, over all the steps of providing a mold which affords the appropriate design for the spout and molding the spout in the collapsed condition with the pleats and the collar 30 concentric and essentially monoplanar.

1. A manually extendible plastic spout for use in combination with a container closure of the type having a deck with a peripherally flanged opening in the deck, said spout comprising:
a reconfigurable plastic body having a first larger diameter end with a peripheral feature adapted to lockingly mate with said flange;
said body further having a second, smaller diameter cylindrical end defining an externally threaded collar; and
a cap threadably engaged with said collar.

2. A spout as defined in claim 1 wherein the cap includes an integral pull ring which can be used to extend the spout from a collapsed condition to an extended condition.

3. A spout as defined in claim 1 further comprising a removable seal internally of said collar.

4. A spout as defined in claim 1 wherein the body is pleated.

5. A spout as defined in claim 1 wherein said feature includes a channel.

6. A spout as defined in claim 5 wherein said channel has a top flange ring which seats on the upper surface of said deck when the spout is installed on said flange.

7. (canceled)

8. In combination:
a molded plastic closure for a open-top container wherein the closure is of the type having a deck with a peripherally-flanged opening formed therein, said flange extending downwardly from the underside of the deck;
a collapsible but manually extendible spout comprising a multiply-pleated plastic body having a first larger diameter inlet end with a peripheral channel adapted to lockingly receive said flange so that the spout body mates with the closure from said underside;
said body further having a second, smaller diameter outlet end with an externally threaded collar; and
a cap threadably engaged with said collar.

9. The combination defined in claim 8 wherein the cap includes an integral pull ring which can be used to extend the spout from a collapsed condition to an extended condition.

10. The combination defined in claim 8 further comprising a removable seal internally of said collar.

11. (canceled)

12. The combination defined in claim 8 wherein said channel includes a detent groove.

13. The combination defined in claim 8 wherein said channel has a top flange ring which seats on the upper surface of said deck when the spout is installed on said flange.

14. The combination defined in claim 8 wherein the pleats are annular.

15. A closure with pull-out pour spout comprising:
a molded plastic closure having a central deck surrounded by an integral, inverted U-shaped peripheral channel portion defining an outer skirt;
an aperture formed in said deck with an inwardly-extending flange having a peripheral lip thereon;
a pull-up spout having an annular base channel for receiving said deck flange therein and a reconfigurable neck portion which, when collapsed, fits substantially wholly within said deck flange; and
a cap threadably engaged with said spout and having a pull grip for lifting said spout from said collapsed condition to an extended condition.

16. The combination defined in claim 15 wherein the threads on the spout are external.

17. The combination defined in claim 15 wherein the grip on said cap is a pull ring integral with said cap.

18. The combination defined in claim 15 wherein the spout is molded with multiple concentric pleats in the collapsed condition such that extension thereof causes an over-center action of said pleats which, when exceeded, leaves the pleated sections of the spout in a stable extended condition.

19. The combination defined in claim 15 further comprising a removable seal internally of said spout and molded integrally therewith.

20. A method of manufacturing a molded plastic spout for installation in an aperture in the deck of a closure wherein the spout is characterized by a large diameter peripheral channel at one end, a small diameter threaded collar at the opposite end and multiple concentric pleats between said ends wherein the method comprises the step of:
molding the spout body in a collapsed, concentrically folded condition.

21. A molded plastic spout assembly for a snap-on closure for an open top container comprising:
a flexible plastic, collapsible but manually extendable spout comprising a flexible body having a substantially cylindrical and externally threaded neck portion integral with a reconfigurable, flexible body which extends radially outwardly to an attachment structure for combination with the closure;
a removable seal molded integrally with and internally of the cylindrical neck; and
a molded plastic cap threadedly engaged onto said neck and having at least one pull ring integrally formed therewith.
